(19) United States
(12) Patent Application Publication
(10) Pub. No.: US 2025/0292932 A1
(43) Pub. Date: Sep. 18, 2025

(54) WIRE HARNESS AND EXTERIOR MEMBER

(71) Applicant: Yazaki Corporation, Tokyo (JP)

(72) Inventors: Ryo Nagashima, Shizuoka (JP); Takashi Ookawa, Shizuoka (JP)

(73) Assignee: Yazaki Corporation, Tokyo (JP)

(21) Appl. No.: 19/050,409

(22) Filed: Feb. 11, 2025

(30) Foreign Application Priority Data
Mar. 13, 2024 (JP) 2024-038572

(51) Int. Cl. H01B 7/40; B60R 16/02; H01B 7/00

(52) U.S. Cl. CPC H01B 7/40; B60R 16/0215; H01B 7/0045

(57) ABSTRACT

A wire harness includes: a wiring member having conductivity; and an exterior member that is attached to the wiring member. The exterior member includes a protective member in which unevenness is formed on a surface and that is formed in a tubular shape to be able to protect the wiring member inserted therein, and a fixing member that is welded to the unevenness of the protective member and is capable of fixing the protective member to a fixing target portion.

### CROSS-REFERENCE TO RELATED APPLICATION(S)

The present application claims priority to and incorporates by reference the entire contents of Japanese Patent Application No. 2024-038572 filed in Japan on Mar. 13, 2024.

### BACKGROUND OF THE INVENTION

### 1. Field of the Invention

The present invention relates to a wire harness and an exterior member.

### 2. Description of the Related Art

For example, Japanese Patent Application Laid-open No. JP 2016-040 969 A discloses a wire harness including an electric wire and a protector capable of protecting the electric wire.

Incidentally, in the wire harness described in Japanese Patent Application Laid-open No. JP 2016-040 969 A described above, a vehicle fixing portion for fixing a protector body portion to a vehicle is welded to the protector body portion. However, for example, in a case where a bonding strength between the protector body portion and the vehicle fixing portion is not appropriate, there is a possibility that the protector body portion cannot be appropriately fixed to the vehicle. Therefore, there is room for further improvement in appropriately fixing an exterior member such as the protector body portion to the vehicle.

### SUMMARY OF THE INVENTION

The present invention has been made in view of the above circumstances, and an object of the present invention is to provide a wire harness and an exterior member that can be appropriately fixed to a vehicle.

In order to achieve the above mentioned object, a wire harness according to one aspect of the present invention includes a wiring member having conductivity; and an exterior member that is attached to the wiring member, wherein the exterior member includes: a protective member in which unevenness is formed on a surface and that is formed in a tubular shape to be able to protect the wiring member inserted into the protective member; and a fixing member that is welded to the unevenness of the protective member and is capable of fixing the protective member to a fixing target portion.

In order to achieve the above mentioned object, an exterior member according to another aspect of the present invention includes a protective member in which unevenness is formed on a surface and that is formed in a tubular shape to be able to protect a conductive wiring member inserted into the protective member; and a fixing member that is welded to the unevenness of the protective member and is capable of fixing the protective member to a fixing target portion.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a side view illustrating a schematic configuration of a wire harness according to the present embodiment;

FIG. 2 is a bottom view illustrating a schematic configuration of an exterior member according to the present embodiment;

FIG. 3 is an enlarged cross-sectional view illustrating a schematic configuration of the exterior member according to the present embodiment;

FIG. 4 is a side view illustrating a schematic configuration of a wire harness according to a modification of the present embodiment; and

FIG. 5 is an enlarged cross-sectional view illustrating a schematic configuration of an exterior member according to the modification of the present embodiment.

### DETAILED DESCRIPTION OF THE PREFERRED EMBODIMENTS

Hereinafter, an embodiment according to the present invention will be described in detail with reference to the drawings. Note that the present invention is not limited by the embodiment. In addition, constituent elements in the following embodiment include those that can be easily replaced by those skilled in the art or those that are substantially the same.

### Embodiment

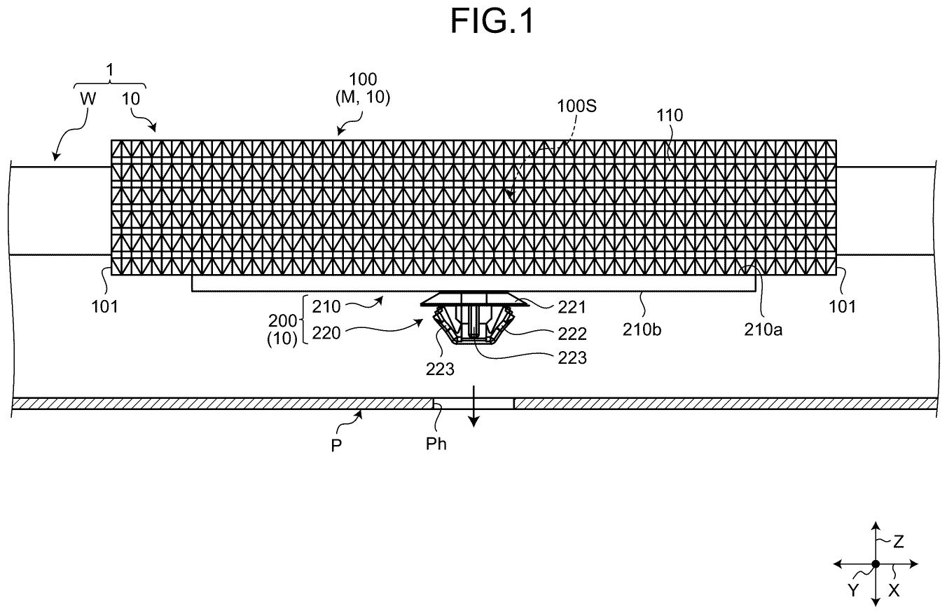

In a wire harness 1 illustrated in FIG. 1, for example, a plurality of wiring members W used for power supply and signal communication are bundled to form a collective component for connection between devices mounted on a vehicle, and the plurality of wiring members W are connected to the devices by a connector or the like.

The wire harness 1 of the present embodiment achieves a configuration in which a fixing member 200 capable of fixing a protective member 100, which is capable of protecting a wiring member W, to a fixing target portion P is welded to unevenness 110 formed on a surface of the protective member 100, so that the wire harness 1 can be appropriately fixed to the vehicle. Hereinafter, each configuration of the wire harness 1 will be described in detail with reference to FIGS. 1 to 3.

Note that the fixing target portion P herein is, for example, a body of a vehicle.

In addition, the wire harness 1 may further include a grommet, a fixture, a connector, and the like.

In addition, in the following description, among a first direction, a second direction, and a third direction intersecting each other, the first direction is referred to as a “length direction X”, the second direction is referred to as a “width direction Y”, and the third direction is referred to as a “height direction Z”. Here, the length direction X, the width direction Y, and the height direction Z are orthogonal to each other. In addition, the length direction X typically corresponds to the extending direction of the wiring member W, the extending direction of the protective member 100, the extending direction of a base portion 210 of the fixing member 200, and the like. In addition, the width direction Y typically corresponds to the width direction of the protective member 100, the width direction of the base portion 210 of the fixing member 200, and the like. In addition, the height direction Z typically corresponds to the height direction of the protective member 100, the thickness direction of the base portion 210 of the fixing member 200, the fitting direction of the fixing member 200 with respect to the fixing target portion P, and the like. Note that each direction used in the following description will be described as a direction in a state where the wire harness 1 is fixed to the fixing target portion P unless otherwise specified.

As illustrated in FIG. 1, the wire harness 1 includes the wiring member W having conductivity and an exterior member 10.

### Wiring Member

The wiring member W is routed in the vehicle and electrically connects each device. The wiring member W of the present embodiment is an insulated electric wire which includes a conductor portion (core wire) having conductivity and an insulating coating portion having insulation, and the conductive portion is coated with the insulating coating portion. The conductor portion herein is a twisted wire obtained by twisting a plurality of strands made of conductive metal. In addition, the insulating coating portion is formed by, for example, extruding an insulating resin material (such as PP, PVC, and crosslinked PE) (appropriately selected in consideration of abrasion resistance, chemical resistance, heat resistance, and the like) or the like. Note that the conductor portion of the wiring member W may be a bundle of a plurality of strands. In addition, one wiring member W may be used, or a wiring member bundle in which two or more wiring members are bundled may be used.

### Exterior Member

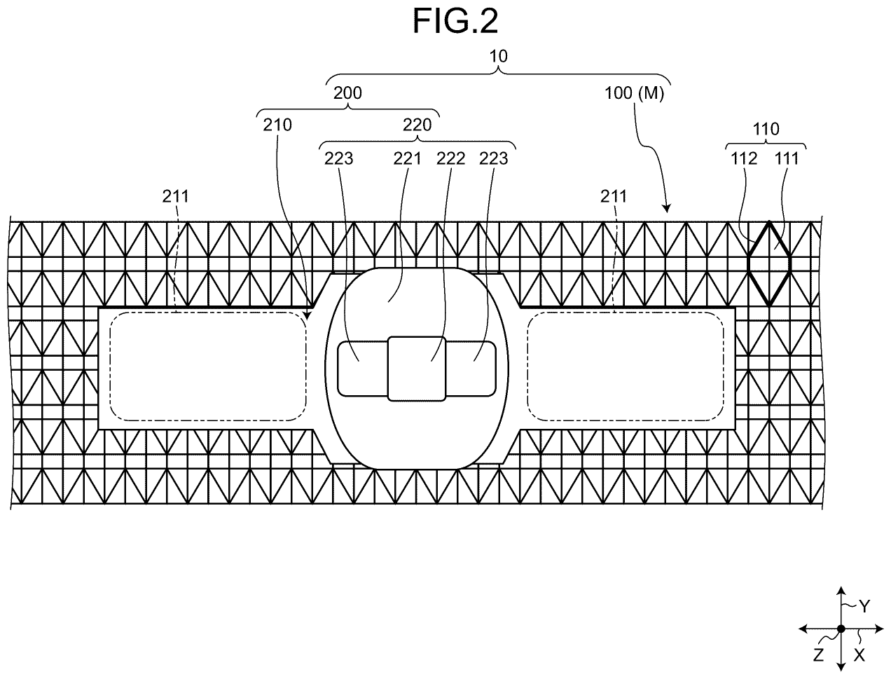

The exterior member 10 is formed of an insulating resin material or the like, and is attached to the wiring member W. As illustrated in FIGS. 1 and 2, the exterior member 10 of the present embodiment includes a protective member 100 and the fixing member 200.

The protective member 100 is formed in a tubular shape and protects the wiring member W inserted therein. The protective member 100 of the present embodiment is formed to have a substantially circular cross-sectional shape along the height direction Z. In addition, as illustrated in FIG. 1, the protective member 100 includes a storage space portion 100S as an internal space and a pair of insertion openings 101 opening in the length direction X, and the wiring member W is inserted into the storage space portion 100S through the pair of insertion openings 101, whereby the wiring member W can be routed along the length direction X which is the extending direction of the protective member 100.

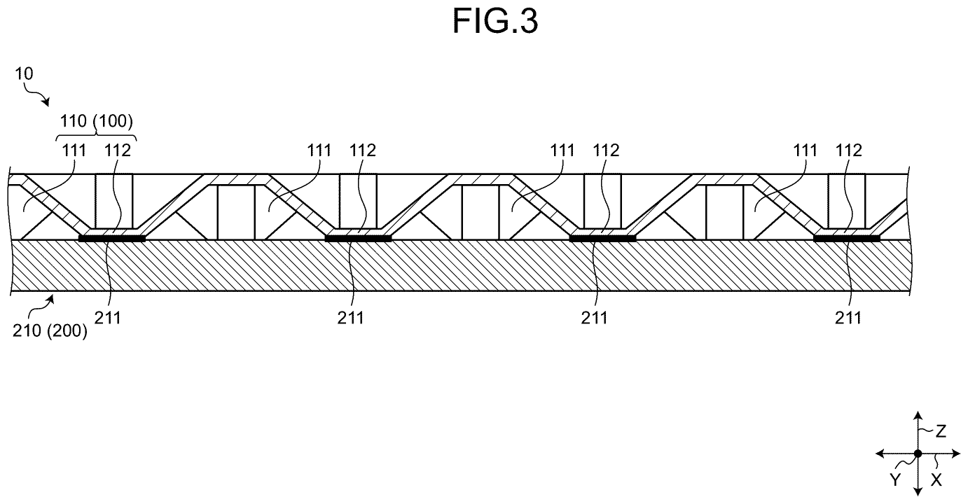

In addition, the unevenness 110 is formed on the surface of the protective member 100. Here, as an example, as illustrated in FIG. 2 and the like, the unevenness 110 includes recesses 111 formed in a hexagonal shape in plan view and arranged alternately, and protrusions 112 formed by ridgelines between the recesses 111. Therefore, as illustrated in FIG. 3, the recesses 111 and the protrusions 112 are arranged alternately in the unevenness 110 of the present embodiment.

In addition, as an example, the protective member 100 is formed by bending a sheet member M into a tubular shape. The sheet member M of the present embodiment is an embossed sheet which is formed of a thermoplastic resin and in which a plurality of recesses 111 are formed by embossing. Therefore, the protective member 100 of the present embodiment can be formed by welding the fixing member 200 to the flat plate-shaped sheet member M and then forming the sheet member M into a cylindrical shape by heat molding, so that workability at the time of welding can be improved. In addition, in the protective member 100, the wiring member W is inserted into the storage space portion 100S through the pair of insertion openings 101, and then a tape winding process is performed to wind tape members around both end portions (portions where the wiring member W is drawn out from the insertion openings 101), whereby the wiring member W is fixed. In addition, the protective member 100 can protect the wiring member W accommodated therein by closing the insertion opening 101 with the tape member.

The fixing member 200 is welded to the unevenness 110 of the protective member 100 to fix the protective member 100 to the fixing target portion P. As illustrated in FIGS. 1 and 2, the fixing member 200 of the present embodiment includes a base portion 210 and a clip portion 220, and each portion is integrally formed by, for example, injection molding a resin material.

The base portion 210 is a foundation portion of the fixing member 200. As illustrated in FIGS. 1 and 2, the base portion 210 of the present embodiment extends along the length direction X, which is the extending direction of the protective member 100, and is formed in a plate shape in which the height direction Z is a plate thickness direction. In addition, as illustrated in FIG. 1, in the base portion 210, the protective member 100 is welded to a principal surface 210a on one side (a surface formed along the length direction X and the width direction Y and having a larger area than other surfaces), and the clip portion 220 is provided on a principal surface 210b on the other side (a surface positioned on the opposite side of the principal surface 210a).

The clip portion 220 is a portion that fixes the protective member 100 to the fixing target portion P. As illustrated in FIGS. 1 and 2, the clip portion 220 of the present embodiment is provided at a central portion of the base portion 210 in the length direction X. In addition, the clip portion 220 is formed so as to protrude in the height direction Z from the principal surface 210b of the base portion 210 (see FIG. 1).

In addition, as illustrated in FIG. 1, the clip portion 220 includes a cap portion 221, a shaft portion 222, and a pair of arm portions 223. Note that the cap portion 221 herein is a portion arranged at a position covering a fixing hole Ph in a state where the clip portion 220 is fixed to the fixing target portion P. In addition, the shaft portion 222 is a portion inserted into the fixing hole Ph of the fixing target portion P in a state where the clip portion 220 is fixed to the fixing target portion P. In addition, the pair of arm portions 223 are configured to be elastically deformable, and is a portion that is caught on the edge portion of the fixing hole Ph of the fixing target portion P in a state where the clip portion 220 is fixed to the fixing target portion P. Therefore, when the clip portion 220 of the present embodiment is inserted into the fixing hole Ph of the fixing target portion P, each of the pair of arm portions 223 bent inward in accordance with the shape of the fixing hole Ph is locked to the edge portion of the fixing hole Ph of the fixing target portion P, whereby the clip portion 220 is fixed to the fixing target portion P.

In addition, in the above configuration, the base portion 210 is positioned with the clip portion 220 interposed therebetween in the length direction X which is the extending direction of the base portion 210, and includes a welded portion 211 welded to the unevenness 110 of the protective member 100.

As illustrated in FIG. 2, a pair of welded portions 211 are provided at both ends in the length direction X of the base portion 210. Therefore, in the fixing member 200 of the present embodiment, the welded portions 211 are provided at intervals along the extending direction of the base portion 210 (that is, the extending direction of the protective member 100), and the base portion 210 can be welded to the protective member 100 at two portions. Therefore, the fixing member 200 can stably fix the clip portion 220 provided on the base portion 210 to the protective member 100.

In addition, as illustrated in FIG. 3, the pair of welded portions 211 are ultrasonically welded in a state where only the protrusions 112 formed on the surface of the protective member 100 are in contact with the welded portions 211. Therefore, in the welded portion 211 of the present embodiment, thermal energy generated at the time of welding can be concentrated on the protrusion 112, and the protrusion 112 can be heated to a melting temperature (more specifically, the melting temperature of the resin constituting the protective member 100) in a short time. Further, the welded portion 211 heats the protrusion 112 to the melting temperature in a short time, and is efficiently welded to the protrusion 112, so that the bonding strength with the protective member 100 can be further strengthened. Furthermore, the welded portion 211 allows the resin melted from the protrusion 112 by the thermal energy generated at the time of welding to flow into a gap formed between the recess 111 and the base portion 210, thereby sufficiently securing a range for welding to the protective member 100 to further strengthen the bonding strength with the protective member 100. Therefore, in the wire harness 1 of the present embodiment, the bonding strength between the protective member 100 and the fixing member 200 can be sufficiently secured by welding the fixing member 200 to the unevenness 110 formed on the surface of the protective member 100.

The wire harness 1 described above includes the wiring member W having conductivity and the exterior member 10 attached to the wiring member W, and the exterior member 10 includes the protective member 100 in which the unevenness 110 is formed on the surface and which is formed in a tubular shape to be able to protect the wiring member W inserted therein, and the fixing member 200 which is welded to the unevenness 110 of the protective member 100 and can fix the protective member 100 to the fixing target portion P.

With such a configuration, the fixing member 200 is welded to the protective member 100, so that the wire harness 1 can be manufactured without performing a subsequent step (for example, a tape winding process or the like) for fixing the fixing member 200 to the protective member 100. In addition, in the wire harness 1, the protective member 100 and the fixing member 200 are integrated into one member, so that the protective member 100 can be fixed to the fixing target portion P without using a band clamp. Therefore, in the wire harness 1 of the present embodiment, not only the cost of members such as a tape member and a band clamp can be reduced, but also the work time required for the assembly can be reduced by simplifying the assembly of the exterior member 10 with respect to the vehicle body.

In addition, in the wire harness 1, by welding the fixing member 200 to the unevenness 110 formed on the surface of the protective member 100, thermal energy generated at the time of welding can be concentrated on the protrusion 112. Therefore, in the wire harness 1, the bonding strength between the protective member 100 and the fixing member 200 can be further strengthened, whereby the bonding strength between the protective member 100 and the fixing member 200 can be sufficiently secured. Therefore, the wire harness 1 and the exterior member 10 of the present embodiment can be appropriately fixed to the vehicle.

Furthermore, the wire harness 1 is welded by utilizing the unevenness 110 on the protective member 100 side, so that the protective member 100 can be fixed to the fixing target portion P without using a separately prepared member even in a case where the protective member 100 is formed of a resin that is difficult to weld. Therefore, the wire harness 1 and the exterior member 10 of the present embodiment can sufficiently secure the bonding strength between the protective member 100 and the fixing member 200 regardless of the constituent material of the protective member 100, and thus can be appropriately fixed to the vehicle.

Further, the protective member 100 described above is formed by bending the sheet member M into a tubular shape. With such a configuration, the protective member 100 is formed of one sheet member M, and can be formed by welding the fixing member 200 to the flat plate-shaped sheet member M and then forming the sheet member M into a cylindrical shape by heat molding, so that workability at the time of welding can be improved. Therefore, the wire harness 1 and the exterior member 10 of the present embodiment can simplify the molding of the protective member 100 and the assembly of the wiring member W to the protective member 100.

Furthermore, the fixing member 200 described above includes the base portion 210 formed in a plate shape and extending along the extending direction (length direction X) of the protective member 100, and the clip portion 220 formed integrally with the base portion 210 and fixable to the fixing target portion P, and the base portion 210 includes a pair of welded portions 211 positioned with the clip portion 220 interposed therebetween in the extending direction (length direction X) of the base portion 210 and welded to the unevenness 110 of the protective member 100. With such a configuration, in the wire harness 1, the clip portion 220 provided in the base portion 210 can be more stably fixed to the protective member 100 by welding the protective member 100 and the base portion 210 of the fixing member 200 at two positions. In addition, the wire harness 1 can sufficiently secure the bonding strength between the protective member 100 and the fixing member 200 with a small welding area by bonding the protective member 100 and the fixing member 200 by welding, and thus the size of the fixing member 200 (particularly, the size of the base portion 210 provided with the welded portion 211) can be reduced. In addition, in the wire harness 1, the welded portion 211 on the fixing member 200 side is provided at a portion other than the clip portion 220 used when the exterior member 10 is attached to the fixing target portion P, so that the clip portion 220 can be prevented from being deformed by thermal energy generated at the time of welding. Therefore, the wire harness 1 and the exterior member 10 of the present embodiment can appropriately fix the protective member 100 to the fixing target portion P via the clip portion 220.

### Modification

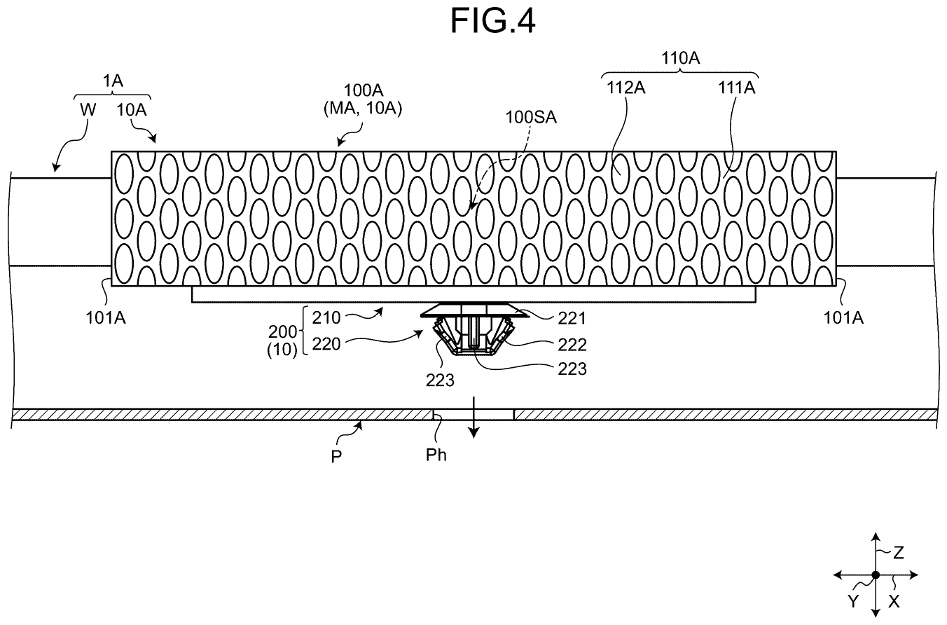

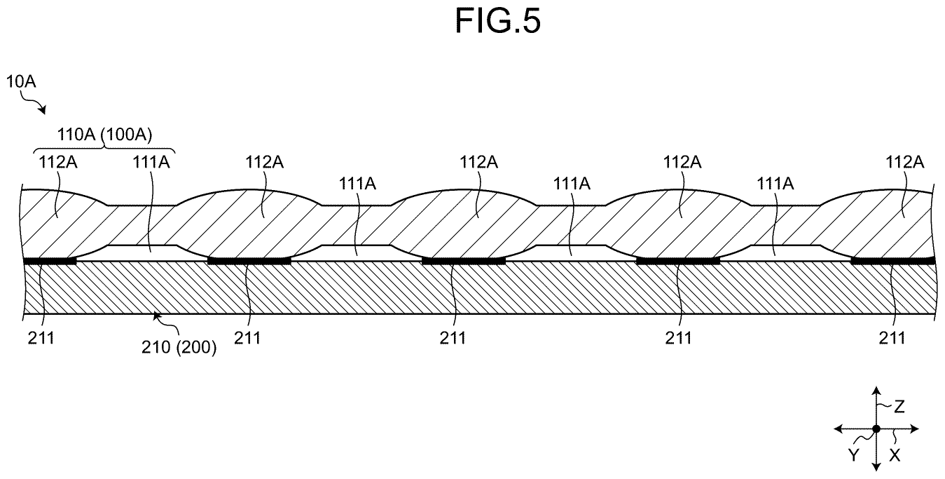

Next, a modification of the wire harness 1 will be described with reference to FIGS. 4 and 5. Although it has been described that the protective member 100 is formed of an embossed sheet, the member (base material) forming the protective member 100 is not limited thereto.

Specifically, in the protective member 100 described above, the recesses 111 arranged alternately and the protrusions 112 formed by the ridgelines between the recesses 111 are formed on the surface, but a protective member 100A described below is different in that protrusions 112A arranged alternately and recesses 111A formed by planes between the protrusions 112A are formed on the surface. Note that in the following description, the same constituent elements as those in the above embodiment are denoted by the same reference numerals, and the detailed description thereof will be omitted.

Specifically, in the protective member 100A, the surface is provided with unevenness 110A having a shape different from that of the unevenness 110 described above. As illustrated in FIG. 4, the unevenness 110A includes the protrusions 112A formed in an elliptical shape in plan view and arranged alternately, and the recesses 111A formed by planes between the protrusions 112A.

In addition, the protective member 100A is a so-called twist tube, and is formed by bending, into a tubular shape, a sheet member MA different from the sheet member M described above and partially overlapping, in a circumferential direction, an end portion of the sheet member MA in a lateral direction. Therefore, similarly to the protective member 100 described above, the protective member 100A can be formed by welding the fixing member 200 to the flat plate-shaped sheet member M and then forming the sheet member M into a cylindrical shape by heat molding, so that workability at the time of welding can be improved. In addition, in the protective member 100A, the wiring member W is inserted into a storage space portion 100SA through a pair of insertion openings 101A, and then the tape members are wound around both end portions (portions where the wiring member W is drawn out from the insertion openings 101A), whereby the wiring member W is fixed. In addition, the protective member 100A can protect the wiring member W accommodated therein by closing the insertion opening 101 with the tape member.

In addition, as illustrated in FIG. 5, the protective member 100A is ultrasonically welded in a state where only the protrusions 112A formed on the surface of the protective member 100A are in contact with the welded portions 211 of the fixing member 200. Therefore, in the welded portion 211 of the present embodiment, similarly to the welded portion 211 described above, thermal energy generated at the time of welding can be concentrated on the protrusion 112A, and the protrusion 112A can be heated to a melting temperature (more specifically, the melting temperature of the resin constituting the protective member 100A) in a short time. Further, the welded portion 211 heats the protrusion 112A to the melting temperature in a short time and is efficiently welded to the protrusion 112A, so that the bonding strength with the protective member 100A can be further strengthened. Furthermore, in the welded portion 211 allows the resin melted from the protrusion 112A by the thermal energy generated at the time of welding to flow into a gap formed between the recess 111A and the base portion 210, thereby sufficiently securing a range for welding to the protective member 100A to further strengthen the bonding strength with the protective member 100A. Therefore, a wire harness 1A and an exterior member 10A of the present embodiment can sufficiently secure the bonding strength between the protective member 100 and the fixing member 200 similarly to the wire harness 1 and the exterior member 10 described above, and thus can be appropriately fixed to the vehicle.

Note that the wire harness 1, 1A and the exterior member 10, 10A according to the above-described embodiment of the present invention are not limited to the above-described embodiment, and various modifications can be made within the scope described in the claims.

For example, the protective member 100, 100A may not be formed by bending a sheet member into a tubular shape.

In addition, the shape of the unevenness 110, 110A formed on the surface of the protective member 100, 100A is not particularly limited.

In addition, the number and positions of the unevenness 110, 110A formed on the surface of the protective member 100, 100A are not particularly limited.

In addition, the configuration of the fixing member 200 is not particularly limited to the form illustrated in FIG. 1 and the like.

In addition, the place where the protective member 100, 100A and the fixing member 200 are welded is not particularly limited.

In addition, the wire harness 1, 1A and the exterior member 10, 10A according to the present embodiment may be configured by appropriately combining the constituent elements of the above-described embodiment.

The wire harness and the exterior member according to the present embodiment provide an effect of being able to be appropriately fixed to a vehicle.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wire harness comprising:
a wiring member having conductivity; and
an exterior member that is attached to the wiring member, wherein
the exterior member includes:
a protective member in which unevenness is formed on a surface and that is formed in a tubular shape to be able to protect the wiring member inserted into the protective member; and
a fixing member that is welded to the unevenness of the protective member and is capable of fixing the protective member to a fixing target portion.

2. The wire harness according to claim 1, wherein
the protective member is formed by bending a sheet member into a tubular shape.

3. The wire harness according to claim 1, wherein
the fixing member includes:
a base portion that is formed in a plate shape and extends along an extending direction of the protective member; and
a clip portion that is formed integrally with the base portion and is fixable to the fixing target portion, and
the base portion includes a pair of welded portions that are positioned with the clip portion interposed therebetween in an extending direction of the base portion and welded to the unevenness of the protective member.

4. The wire harness according to claim 2, wherein
the fixing member includes:
a base portion that is formed in a plate shape and extends along an extending direction of the protective member; and
a clip portion that is formed integrally with the base portion and is fixable to the fixing target portion, and
the base portion includes a pair of welded portions that are positioned with the clip portion interposed therebetween in an extending direction of the base portion and welded to the unevenness of the protective member.

5. An exterior member comprising:
a protective member in which unevenness is formed on a surface and that is formed in a tubular shape to be able to protect a conductive wiring member inserted into the protective member; and
a fixing member that is welded to the unevenness of the protective member and is capable of fixing the protective member to a fixing target portion.
